(19) United States
(12) Patent Application Publication
(10) Pub. No.: US 2008/0252158 A1
(43) Pub. Date: Oct. 16, 2008

(54) TORQUE RESISTANT TERMINAL BLOCK ASSEMBLY

(75) Inventors: Brent David Yohn, Newport, PA (US); Lawrence Se-Jun Oh, Hummelstown, PA (US); Craig Maurice Campbell, Camp Hill, PA (US); Henry Otto Herrmann, Elizabethtown, PA (US)

Correspondence Address: TYCO TECHNOLOGY RESOURCES, 4550 NEW LINDEN HILL ROAD, SUITE 140, WILMINGTON, DE, 19808-2952, US

(73) Assignee: TYCO ELECTRONICS CORPORATION, Middletown, PA (US)

(21) Appl. No.: 11/735,622

(22) Filed: Apr. 16, 2007

(51) Int. Cl. H02K 11/00

(52) U.S. Cl. 310/71; 29/592.1

(57) ABSTRACT

A power terminal having a unitary connector body. The body includes at least one opening therethrough. The opening is configured to receive an electrically conductive member. The body further includes a recess configured to receive a cap portion of the electrically conductive member. The connector body has an electrically insulative coating on at least a portion of a surface thereof. The insulative coating provides sufficient electrical insulation to substantially prevent electrical communication between the electrically conductive member and the connector body. A method for fabricating a power terminal is also provided.

### FIELD OF THE INVENTION

The present invention is directed to electrical connectors. In particular, the present invention is direct to electrical terminal block assemblies resistant to torque applied to the terminals.

### BACKGROUND OF THE INVENTION

A wide variety of terminal block assemblies exist for use today, depending upon the environment and application for which it is intended. In some applications, multiple sets of wires within an end product are joined within the terminal block assembly to external power cords and other types of wire. Examples of this application may be found in various environments, such as in aircraft electrical and power systems or in manufacturing where equipment is utilized having high power demands.

Further, conventional terminal block assemblies may be difficult to manufacture and may potentially become damaged or disassembled over time. In general, conventional terminal block assemblies include a housing formed of an insulative material and shaped to provide one or more regions therein to receive conductive terminal block connectors. Each terminal block connector is configured to join a power line from the end product (e.g., an electrical device) and a corresponding power cord from the power source. Each terminal block connector is held within the insulated housing of the terminal block assembly through a separate fastening means, such as rivets, bolts, screws, and similar electrical connection devices. Over the life of the terminal block assembly, the terminals within the terminal block may become loose or disconnected. In particular, some terminal block applications require a large torque force on the terminals to sufficiently secure the electrical connection. These large torque forces may result in failure of the terminal block by fracture of the housing at the mounting points and/or breakage or unintentional disengagement of the terminals from the terminal block.

What is needed is a terminal block and housing having resistance to torque and permitting the securing of the terminals with sufficient retaining force to prevent unintentional disengagement of the electrical connections thereto.

### SUMMARY OF THE INVENTION

One aspect of the present invention includes a power terminal having a substantially unitary connector body. The body includes at least one opening therethrough. The opening is configured to receive an electrically conductive member. The body further includes a recess configured to receive a cap portion of the electrically conductive member. The connector body has an electrically insulative coating on at least a portion of a surface thereof. The insulative coating provides sufficient electrical insulation to substantially prevent electrical communication between the electrically conductive member and the connector body.

Another aspect of the present invention includes a method for forming a power terminal. The method includes providing a substantially unitary connector body. The connector body includes at least one opening therethrough. The opening is configured to receive an electrically conductive member. The body further comprises a recess configured to receive a cap portion of the electrically conductive member. An electrically insulative coating is applied on at least a portion of a surface the connector body. The insulative coating provides sufficient electrical insulation to substantially prevent electrical communication between the electrically conductive member and the connector body.

One advantage of an embodiment of the present invention is that the unitary connector body may be easily formed with few processing steps.

Another advantage of an embodiment of the present invention is that the unitary connector body may be fabricated from any material, including conductive materials that provide the mechanical properties desired for the terminal block.

Still another advantage of an embodiment of the present invention is that the conductive members may be sufficiently engaged to the connector body such that rotation of the conductive member is substantially prevented, even under high torque, including torque in excess of 200 lb.-in. or more.

Still another advantage of an embodiment of the present invention is that the unitary body is resistant to repeated cycles of engagement of wires to the conductive members, while retaining the resistance to torque, damage breakage and/or fatigue.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 illustrates a power terminal 100 according to an embodiment of the present invention.

FIG. 2 shows a top perspective view including a cross-section taken along line 2-2 of FIG. 1 of a power terminal 100 according to an embodiment of the present invention.

FIG. 3 shows a bottom perspective view including a cross-section taken along line 2-2 of FIG. 1 of a power terminal 100 according to an embodiment of the present invention.

FIG. 4 shows a top perspective view including traverse, partial cross-sections of a power terminal 100 according to an embodiment of the present invention.

Wherever possible, the same reference numbers will be used throughout the drawings to refer to the same or like parts.

### DETAILED DESCRIPTION OF THE INVENTION

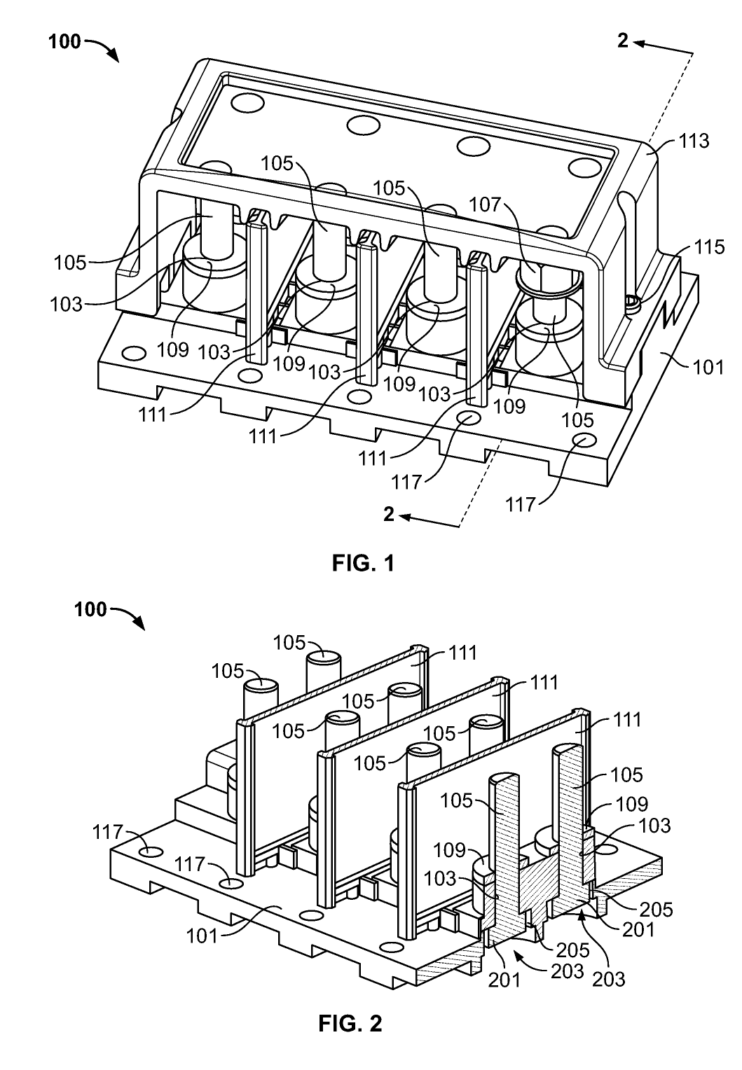

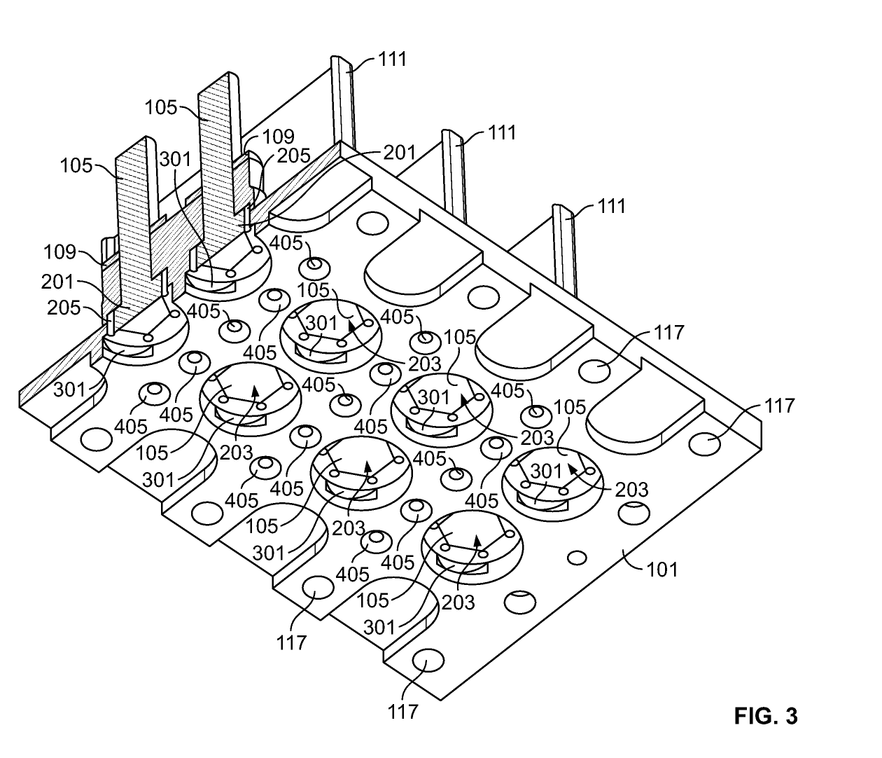

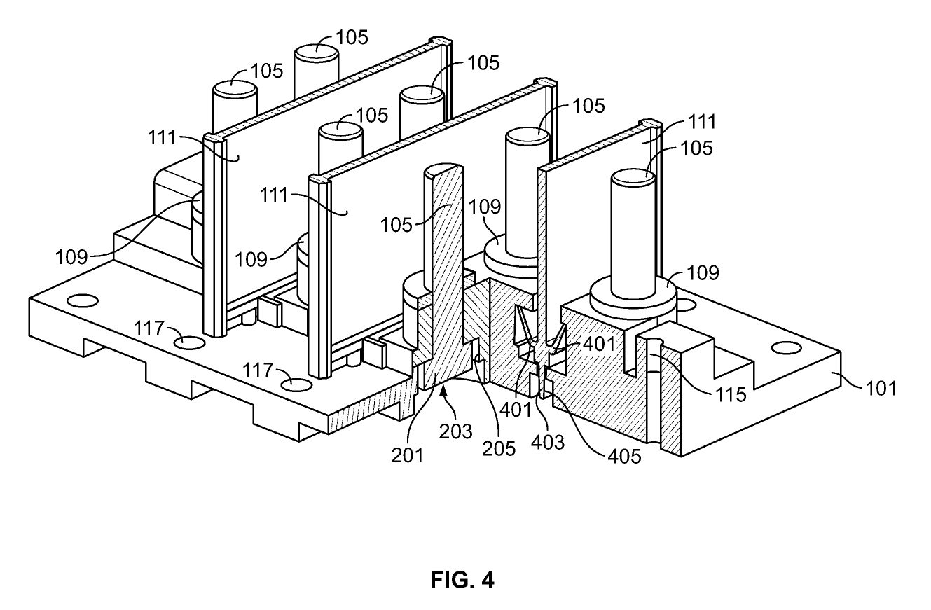

FIG. 1 illustrates a power terminal 100 according to an embodiment of the present invention. Power terminal 100 includes a terminal body 101 formed from a unitary component. The connector body 101 is preferably fabricated from a rigid material, such as aluminum or aluminum alloys or other metals or conductive materials. The connector body 101 further includes a plurality of openings 103 formed in the connector body 101. The openings 103 may be formed in the connector body utilizing any suitable technique, including machining, casting, or any other known fabrication technique. Openings 103 are configured to receive an electrically conductive member 105. The conductive member 105 includes threading along at least a portion of the surface, where the conductive member 105 forms the terminal that is useful for connecting to wires or other electrical devices. The portion of the conductive members 105 received by opening 103 may or may not be threaded. As shown in FIG. 1, electrically conductive members 105 are disposed within openings 103 and are preferably engaged with openings 103 of connector body 101. The threading parameters of the electrically conductive member 105 are not particularly limited and may include any suitable pitch, diameter or geometry. The threading of conductive members 105 is preferably such that a nut 107 or similar device may the threadingly engaged with conductive member 105 to provide electrical contact. The electrically conductive member 105 may be a bolt, rivet, screw or similar screw-like configuration, wherein the conductive member 105 includes a cap 201 (see e.g., FIG. 2). The geometry of cap 201 is preferably such that a corresponding geometry of antirotation cavity 205 within recess 203 may be configured to receive the cap 201 and substantially prevent rotation. In one embodiment the cap 201 includes a hexagonal geometry, wherein the antirotation cavity 205 is configured to receive the hexagonal cap 201 (see e.g., FIGS. 3 and 4). The configuration of the cap 201 is not particularly limited and may include any cap 201 geometry known for providing the engagement against the connector body 101, such as a pan head geometry, button or dome head geometry, a round head geometry, a truss head geometry, a flat head geometry, an oval head geometry, hex or socket head geometry, or any other suitable cap geometry.

In addition to conductive member 105, a nut 107 or similar device may be provided and rotatably disposed upon conductive member 105. Nut 107 is preferably tapped with corresponding threading to conductive member 105 and rotates in a manner that provides an engagement sufficient to provide electrical connectivity between wires (not shown in FIG. 1). For example, a wire having a pig-tail or other conventional wire connector may be placed in contact with the conductive member 105 and nut 107 may be rotated to engage the wire connector in physical contact with the conductive member. The rotational torque applied to the nut 107 may be provided by a wrench or similar device, wherein sufficient torque is provided to resist unintentional disengagement of the nut 107 from conductive member 105. The connector body 101 is fabricated from a material that is sufficiently rigid to resist bending, breakage or damage as a result of the torque provided to the conductive member 105 and nut 107. In a preferred embodiment, the connector body 101 is sufficiently rigid to resist a high torque. For example, the connector body 101 is preferably sufficiently rigid to resist a torque of greater than about 200 lb-in. applied to the conductive members 105. Further, the connector body 101 is configured with dimensions and a geometry that provides resistance to the torque on conductive member 105 and nut 107. Rotation of conductive member 105 within opening 103 and may further be inhibited and resistance to torque may be increased by application of adhesive or similar compositions bonding the surface of the conductive member 105 to the surface of opening 103. The power terminal 100 may further include an electrically conductive washer 109 installed so that the wire is disposed between nut 107 and the washer 109 to improve the electrical connectivity of the wire to the conductive member 105 when nut 107 engages the wire.

In another embodiment of the present invention, washer 109 may configured as a commoning washer that is configured to span two or more conductive members 105 and function as an electrical jumper between conductive members 105 in order to provide electrical connectivity between conductive members. In this embodiment, washer 109 may include any geometry that permits contact with two or more conductive members 105, including but not limited to, an oval geometry, a figure-eight geometry, a bar or other elongated geometry configured to contact and engage each of the desired conductive members 105.

In order to provide separation between conductive member 105 pairs or other groupings, dividers 111 may be disposed between conductive member 105 groupings. As shown in FIG. 1, the conductive members 105 may be grouped in pairs of conductive members 105 that may or may not be directly electrically connected by washers 109 or other devices. The dividers 111 are fabricated from an insulating material, such as, but not limited to a thermoplastic or other polymer. The dividers are preferably sufficiently rigid to provide resistance to breakage during rotation and engagement of nuts 109 with conductive member 105. In another embodiment, dividers 111 are formed as a unitary component with the connector body 101.

As shown in FIG. 1, the terminal block 100 preferably further includes a cover 113 fabricated from an electrically insulative material, such as a thermoplastic or other polymer. The cover 113 is preferably sufficiently rigid to prevent unintentional damage, when the terminal block 100 is connected to wires or other electrical devices. In addition, cover 113 preferably provides protection against electrical shock, shorting or arcing when power is applied to the power terminal 100. Cover 113 is preferably attached to the connector body 101 by cover mount 115, which includes any suitable fastening arrangement, such as a screwing or bolting arrangement.

Terminal block 100 also includes mounting opening 117 preferably arranged along a peripheral edge of the connector body 101. The mounting openings 117 may include machined openings or formed openings configured to receive a fastener. The configuration of mounting openings 117 may be any geometry that provides the capability of fastening the terminal block in a location having the desired accessibility to wires or other electrical devices requiring connectivity.

The connector body 101 includes an electrically insulated coating on at least a portion of the surface thereof. In one embodiment, the electrically insulated coated completely covers the surface of the connector body including the openings 103 and the surfaces configured to engage dividers 111. The insulative coating may be any suitable insulative material that provides the necessary mechanical properties to withstand repeated engagement and disengagement of the nuts 109 and electrical insulative properties sufficient to prevent shorting, arcing or undesired electrical conduction. In other words, the insulative coating provides sufficient electrical insulation to substantially prevent electrical communication between the electrically conductive member and the connector body.

The insulative coating may be applied by any suitable method known in the art. In one embodiment, the insulative coating is a powder coating, such as, but not limited to, electrostatically applied thermoplastic or thermoset polymer. To apply the electrically insulated coating, dry, preferably solventless thermoplastic or thermoset polymer particles are electrostatically applied to the surface of the connector body 101. Thereafter, the particles are exposed to heat, such as heat from a heat gun or an oven and permitted to flow and cure to form an insulative coating. The insulative coating may be applied over the entire connector body 101 or selectively by selective application and/or masking of the connector body 101. For example, selective application of the insulative coating may be provided by coating the entire conductor body 101, wherein portions of the insulative coating are removed, as desired.

FIG. 2 shows a top perspective view including a cross-section taken along line 2-2 of FIG. 1 of a power terminal 100 according to an embodiment of the present invention. As shown in the cross-section, conductive member 105 pass through opening 103, wherein cap 201 is engaged in contact with connector body 101. The connector body 101 includes a recess 203 on the side of the connector body 101 engaging cap 201, wherein the recess 203 provides a space or cavity into which a potting material may be placed to provide electrical insulation from conductive member 105. In addition, recess further includes an antirotation cavity 205 which provides a cavity having a geometry configured to receive a corresponding geometry of a cap 201. Cap 201 is received by an antirotation cavity 205 where antirotation cavity 205 preferably has a geometry that similar to or provides a geometry having surfaces to which the cap 201 geometry may engage and substantially prevents rotation of the conductive member 105. Features known in the art useful for machining or forming the geometry of antirotation cavity 205 may also be present in antirotation cavity 205. For example, rounded or drilled features reducing or eliminating sharp edges may also be present. Potting material may include any formable insulative material known in the art as potting material for electrical connector assemblies. Suitable potting materials include epoxies, silicones, urethanes, copolymers or other electrically insulative material. The potting material is formable over cap 201 and is preferably sufficiently rigid, when cured, to retain conductive member 105 in opening 103 and provide additional resistance to rotation of conductive member 105. Potting compound may also flow into cavities present in the antirotation cavity 205, further providing increased engagement of the conductive member 105 and additional resistance to rotation. In one embodiment of the present invention, the cap 201 may further be coated with insulative material, such as powder coating. In another embodiment, the surface of conductive member 105 engaging opening 103 may also be coated with an insulative material, such as powder coating. Application of the insulative coating to the conductive member 105 may take place using any suitable technique known in the art for applying insulative material and may include the same or different coating than the insulative coating applied to the connector body 101.

FIG. 3 shows a bottom perspective view including a cross-section taken along line 2-2 of FIG. 1 of a power terminal 100 according to an embodiment of the present invention. The connector body 101 includes recesses 203, each corresponding to a conductive member 105. The recesses 203 preferably have sufficient volume to receive potting material. The potting material may be disposed into recess 203 and cured, hardened or otherwise formed into an electrically insulated material, which provides electrical insulation for the conductive member 105, provides resistance to rotation for the conductive member 105, prevents pushing out (i.e., disengagement) of conductive member 105 and protects cap 201 from damage or contact. Recess 203 preferably includes cavity 301 formed into the connector body 101 within recess 203. Cavity 301 provides a feature into which potting material may flow. The features of cavity 301 form surfaces that are arranged to provide additional retention of the potting material and prevent unintentional removal or damage to the potting material within recess 203. FIG. 3 further illustrates openings 405 for receiving divider 111, as shown and described below with respect to FIG. 4.

FIG. 4 shows a top perspective view including traverse, partial cross-sections of a power terminal 100 according to an embodiment of the present invention with the section taken from two transverse directions through the power terminal 100. The arrangement of the conductive members 105 and the connector body 101 are substantially as shown and described with respect to FIGS. 1-3. In addition, the sectional view cut through divider 111 illustrates divider features 401, which extend outward from the divider 111 and engage one or more surfaces of connector body 101. The features 401 preferably are configured to lock into position upon insertion of the divider 111 into the connector body 101. The geometry of features 401 is not particularly limited and may include wings, latches, protrusions or other features that provide engagement with connector body 101. Protrusions 403 may be ultrasonically or thermally formed-over to form a rivet-like head to lock divider in place. This may be used instead of or in addition to features 401. In addition to features 401, protrusions 403 of divider 111 extend through openings 405 formed in connector body 101 to align and provide additional retention of divider 111. The geometry and quantity of protrusions is not particularly limited and may include any arrangement that provides sufficient retention of dividers 111. In another embodiment of the invention, openings 405 may be omitted and the dividers may be retained and terminate within connector body 101. In still another embodiment, dividers 111 are formed as a unitary component with the connector body 101.

While the above power terminal 100 has been shown and described with respect to an eight terminal (i.e., eight conductive member 105) arrangement, the power terminal 100 may be arranged in any suitable manner with any number of conductive member 105 that provides the connectivity of wires or electrical devices. In addition, although the power terminal 100 shown and described includes conductive member 105 pairs, any grouping of conductive members 105, including single conductive members, may be provided and may be separated utilizing dividers 111 or may be disposed and/or spaced in groups of conductive members 105 without utilizing dividers 111.

In still another embodiment, the antirotation cavity 205 of recess 203 may be omitted and the openings 103 may be mechanically threaded with a helical ridge or other suitable material feature, capable of threading engagement with the electrically conductive member 105. For example, the conductive member may be a socket head cap screw, wherein the opening 103 has been tapped with a corresponding threading arrangement. In this embodiment, the rotation of conductive member 105 may be substantially prevented by engagement of the threading of the opening 103 and the conductive member 105. Further, in this embodiment, preferably both the opening 103 and the portion of the conductive member 105 engage the opening 103 are preferably coated with an insulative coating. Potting compound and/or adhesive or thread locking compound may further provide resistance to rotation.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A power terminal comprising:
a unitary connector body, the connector body having at least one opening therethrough, the opening being configured to receive an electrically conductive member, the connector body further comprising a recess configured to receive a cap portion of the electrically conductive member;
the connector body having an electrically insulative coating on at least a portion of a surface thereof, the insulative coating providing sufficient electrical insulation to substantially prevent electrical communication between the electrically conductive member and the connector body.

2. The power terminal of claim 1, wherein the connector body is fabricated from a metallic material.

3. The power terminal of claim 2, wherein connector the body is fabricated from aluminum or aluminum alloys.

4. The power terminal of claim 1, further comprising the electrically conductive member engaged with the connector body.

5. The power terminal of claim 4, wherein the connector body is sufficiently rigid to resist torque applied to the conductive members.

6. The power terminal of claim 5, wherein the body is sufficiently rigid to resist torque of at least 200 lb-in. applied to the conductive members.

7. The power terminal of claim 1, wherein the electrically insulative coating is a powder coating.

8. The power terminal of claim 1, wherein the electrically insulative coating is a thermoplastic polymer or thermoset polymer.

9. The power terminal of claim 1, wherein the electrically insulative coating is disposed on a surface of the opening.

10. The power terminal of claim 1, wherein the cap portion further comprises a coating of electrically insulative material.

11. The power terminal of claim 1, further comprising a potting material disposed in the recess.

12. The power terminal of claim 1, wherein the recess further includes an antirotation cavity having a geometry that corresponds to the geometry of the cap portion.

13. The power terminal of claim 1, wherein the connector body comprises a pluarlity of openings.

14. The power terminal of claim 1, wherein the connector body further comprises electrically insulative dividers engaged with the connector body and disposed to arrange groups of electrically conductive members.

15. The power terminal of claim 1, wherein the connector body further includes a cover.

16. The power terminal of claim 1, wherein the body further includes mounting holes configured to receive mounting fasteners.

17. A method for forming a power terminal comprising:
providing a unitary connector body, the connector body having at least one opening therethrough, the opening being configured to receive an electrically conductive member, the connector body further comprising a recess configured to receive a cap portion of the electrically conductive member;
applying an electrically insulative coating on at least a portion of a surface the connector body;
wherein the insulative coating provides sufficient electrical insulation to substantially prevent electrical communication between the electrically conductive member and the connector body.

18. The method of claim 17, wherein applying includes electrostatically applying a polymeric coating to at least a portion of the surface of the connector body.

19. The method of claim 17, wherein the body is sufficiently rigid to resist torque applied to the conductive members.

20. The method of claim 17, further comprising engaging the conductive member with the connector body.
